(19) United States
(12) Patent Application Publication
(10) Pub. No.: US 2015/0116471 A1
(43) Pub. Date: Apr. 30, 2015

(54) METHOD, APPARATUS AND STORAGE MEDIUM FOR PASSERBY DETECTION

(71) Applicant: Wistron Corporation, New Taipei City (TW)

(72) Inventor: Chih-Sung Chang, New Taipei City (TW)

(73) Assignee: Wistron Corporation, New Taipei City (TW)

(21) Appl. No.: 14/197,222

(22) Filed: Mar. 5, 2014

(30) Foreign Application Priority Data
Oct. 30, 2013 (TW) 102139349

(51) Int. Cl. H04N 5/232; G06K 9/00; H04N 7/18

(52) U.S. Cl. CPC H04N 5/23219; H04N 7/18; G06K 9/00255; G06K 9/00362
USPC 348/77

(57) ABSTRACT

A method, an apparatus and a storage medium for passerby detection, adapted to an electronic apparatus having an image capturing unit, are provided. In the method, an image is captured by the image capturing unit. At least one face appeared in the image is detected, and a position of at least one characteristic of each of the faces is obtained. A characteristic value of each of the faces is calculated according to the position of each characteristic. A ratio of at least one of the characteristic values to a reference value is calculated and compared with a threshold. When the ratio is smaller than the threshold, it is determined that at least one passerby is included in the image.

### CROSS-REFERENCE TO RELATED APPLICATION

This application claims the priority benefit of Taiwan application serial no. 102139349, filed on Oct. 30, 2013. The entirety of the above-mentioned patent application is hereby incorporated by reference herein and made a part of this specification.

### BACKGROUND OF THE INVENTION

1. Field of the Invention

The invention relates to an application of a face detection technology, and more particularly to a method, an apparatus and a storage medium for passerby detection.

2. Description of Related Art

With the advances in image capturing technologies, digital cameras and electronic apparatuses having the image capturing function such as cell phones and tablet computers are popularized nowadays, and various new functions have been proposed to facilitate a user in capturing images.

Currently, various applications have been designed to help the user to take the images closer to what the user has expected. Therein, an application for removing a passerby from an image is provided in Android operation system. Such application may continuously take a plurality of images so as to detect moving objects therein, select the objects to be removed according to the manual selection of the user, and use an image synthesis technology to achieve the purpose of removing the passerby.

However, although the application is capable of removing the passerby from the image, such technology may require continuously taking a great amount of images, which leads to waste in storage space and computation resources for the system. On the other hand, said technology may only remove the moving objects from the image. In case a subject to be taken is moving, or the objects to be removed are not moving, the passerby may not be accurately removed from the image. Accordingly, it is necessary to provide a more convenient method to detect the passerby in the image and facilitate the user in capturing the images excluding the passerby.

### SUMMARY OF THE INVENTION

The invention is directed to a method, an apparatus and a storage medium for passerby detection, which are capable of automatically detect whether a passerby is included in an image so as to facilitate a user in taking images excluding the passerby.

The method for passerby detection is adapted to an electronic apparatus having an image capturing unit. In the method, an image is captured by the image capturing unit. Next, at least one face appeared in the image is detected, and a position of at least one characteristic of each of the faces is obtained. Thereafter, a characteristic value of each of the faces is calculated according to the position of each characteristic. A ratio of at least one of the characteristic values to a reference value is then calculated and compared with a threshold. When the ratio is smaller than the threshold, it is determined that at least one passerby is included in the image.

In an embodiment of the invention, the step of calculating the ratio of the at least one of the characteristic values to the reference value includes: calculating a ratio of a minimum among the characteristic values to the reference value, and determining that the at least one passerby is included in the image when the ratio is smaller than the threshold.

In an embodiment of the invention, the step of calculating the ratio of the at least one of the characteristic values to the reference value includes: calculating ratios of the characteristic values to the reference value respectively, determining that the at least one passerby is included in the image when any one of the ratios is smaller than the threshold, and recognizing that the face to which the characteristic value corresponding to the ratio smaller than the threshold belongs is the at least one passerby.

In an embodiment of the invention, the step of calculating the ratio of the at least one of the characteristic values to the reference value includes: calculating a ratio of a randomly-selected characteristic value among the characteristic values to the reference value, and determining that the at least one passerby is included in the image once the ratio is smaller than the threshold.

In an embodiment of the invention, the method further includes: prohibiting taking the image when it is determined that the at least one passerby is included in the image captured by the image capturing unit.

In an embodiment of the invention, the method further includes: permitting taking the image and recording the image as an image file when it is determined that the at least one passerby is not included in the image captured by the image capturing unit.

In an embodiment of the invention, the at least one characteristic includes two eyes and a mouth, and the step of calculating the characteristic value of each of the at least one face according to the position of the at least one characteristic includes: calculating an area of a triangle formed by positions of the two eyes and the mouth of each of the at least one face, and setting the area as the characteristic value of the face.

In an embodiment of the invention, the at least one characteristic includes a face positioning frame embracing each of the at least one face, and the step of calculating the characteristic value of each of the at least one face according to the position of the at least one characteristic includes: calculating an area of the face positioning frame embracing each of the at least one face, and setting the area as the characteristic value of the face.

In an embodiment of the invention, the at least one characteristic includes two eyes, and the step of calculating the characteristic value of each of the at least one face according to the position of the at least one characteristic includes: calculating a distance between the two eyes, and setting the distance as the characteristic value of the face.

In an embodiment of the invention, before the step of calculating the ratio of at least one of the characteristic values to the reference value, and comparing the ratio with the threshold, the method further includes: adjusting a focal length of the image capturing unit to enable the image capturing unit to focus on one or more of the at least one face, and setting an average value of the characteristic values of the at least one face focused by the image capturing unit as the reference value among the characteristic values.

In an embodiment of the invention, the step of adjusting the focal length of the image capturing unit to enable the image capturing unit to focus on the one or more of the at least one face includes: receiving a selecting operation of a user on one of the at least one face, and accordingly adjusting the focal length of the image capturing unit to enable the image capturing unit to focus on the one of the at least one face selected by the selecting operation.

In an embodiment of the invention, after the step of setting the average value of the characteristic values of the at least one face focused by the image capturing unit as the reference value among the characteristic values, the method further includes: respectively calculating a ratio of each of the characteristic values to the reference value, and comparing the ratio with the threshold; and determining that the at least one face having the corresponding characteristic value is one of the at least one passerby when the ratio is smaller than the threshold.

In an embodiment of the invention, before the step of calculating the ratio of at least one of the characteristic values to the reference value, and comparing the ratio with the threshold, the method further includes: receiving a selecting operation of a user on one of a plurality of sensitivities, and accordingly selecting a predetermined threshold corresponding to the selected sensitivity from a plurality of predetermined thresholds as the threshold to be compared with the ratio.

In an embodiment of the invention, before the step of calculating the ratio of at least one of the characteristic values to the reference value, and comparing the ratio with the threshold, the method further includes: calculating an average value or a median of the characteristic values or fetching a maximum among the characteristic values, and setting the average value, the median or the maximum as the reference value.

In an embodiment of the invention, when it is determined that the at least one passerby is included in the image captured by the image capturing unit, the method further includes: sending a warning message to notify a user that the at least one passerby is included in the image.

The apparatus for passerby detection of the invention includes an image capturing unit, a storage unit and one or more processing units. Therein, the image capturing unit is configured to capture an image. The storage unit is configured to store a plurality of modules. The processing unit is coupled to image capturing unit and the storage unit, and configured to access and execute the modules recorded in the storage unit. The modules include an image capturing module, a face detection module, a characteristic value calculating module, a comparing module and a determining module. Therein, the image capturing module is configured to capture the image by utilizing the image capturing unit. The face detection module is configured to detect at least one face appeared in the image, and obtain a position of at least one characteristic of each of the at least one face. The characteristic value calculating module is configured to calculate a characteristic value of each of the at least one face according to the position of at least one characteristic. The comparing module is configured to calculate a ratio of at least one of the characteristic values to a reference value, and compare the ratio with a threshold. The determining module is configured to determine that at least one passerby is included in the image when the ratio is smaller than the threshold.

The invention also provides a storage medium which stores programs to be loaded into an electronic apparatus to perform steps of: capturing an image by utilizing an image capturing unit of the electronic apparatus; detecting at least one face appeared in the image, and obtaining a position of at least one characteristic of each of the at least one face; calculating a characteristic value of each of the at least one face according to the position of the at least one characteristic; calculating a ratio of at least one of the characteristic values to a reference value, and comparing the ratio with a threshold; and determining that at least one passerby is included in the image when the ratio is smaller than the threshold.

Based on above, the method, the apparatus and the storage medium for passerby detection according to the embodiments of the invention calculate the ratio of the characteristic value of the face to the reference value, and compare the ratio with the threshold corresponding to the sensitivity for passerby detection, so as to determine whether the passerby is included in the image and accordingly decide whether to take and store the image. As a result, the user is allowed to capture the image excluding the passerby more conveniently and intuitively.

To make the above features and advantages of the disclosure more comprehensible, several embodiments accompanied with drawings are described in detail as follows.

### BRIEF DESCRIPTION OF THE DRAWINGS

FIG. 1 is a block diagram illustrating an apparatus for passerby detection according to an embodiment of the invention.

FIG. 2 is a flowchart illustrating a method for passerby detection according to an embodiment of the invention.

FIG. 3 is an example illustrating the method for passerby detection according to an embodiment of the invention.

FIG. 4 is an example illustrating the method for passerby detection according to an embodiment of the invention.

FIG. 5 is an example illustrating the method for passerby detection according to an embodiment of the invention.

FIG. 6 is an example illustrating the method for passerby detection according to an embodiment of the invention.

FIG. 7 is a flowchart illustrating a method for passerby detection according to an embodiment of the invention.

### DESCRIPTION OF THE EMBODIMENTS

In view of observation made to scenarios in portrait photography, it can be known that the subject to be taken is usually closer to the camera when a user is taking photos, and occupies a relatively larger area in the image captured by the camera. In contrast, a passerby, as a non-subject, is usually father away from the camera, and occupies a relatively smaller area in the image. Therefore, it can be known that the areas of the subject and the passerby occupied in the image are usually not equal to each other, but having a certain difference in proportion. Accordingly, a face area or a distance between two eyes in each face is used as a reference in the invention. When the difference between the face areas or the distances is over a certain level, it is then determined that the passerby is included in the image, and a shutter of the camera may also be controlled to prevent the image including the passerby from being taken by the user. As a result, an automatic passerby detection to the image may be realized for providing the user to conveniently take the image excluding the passerby.

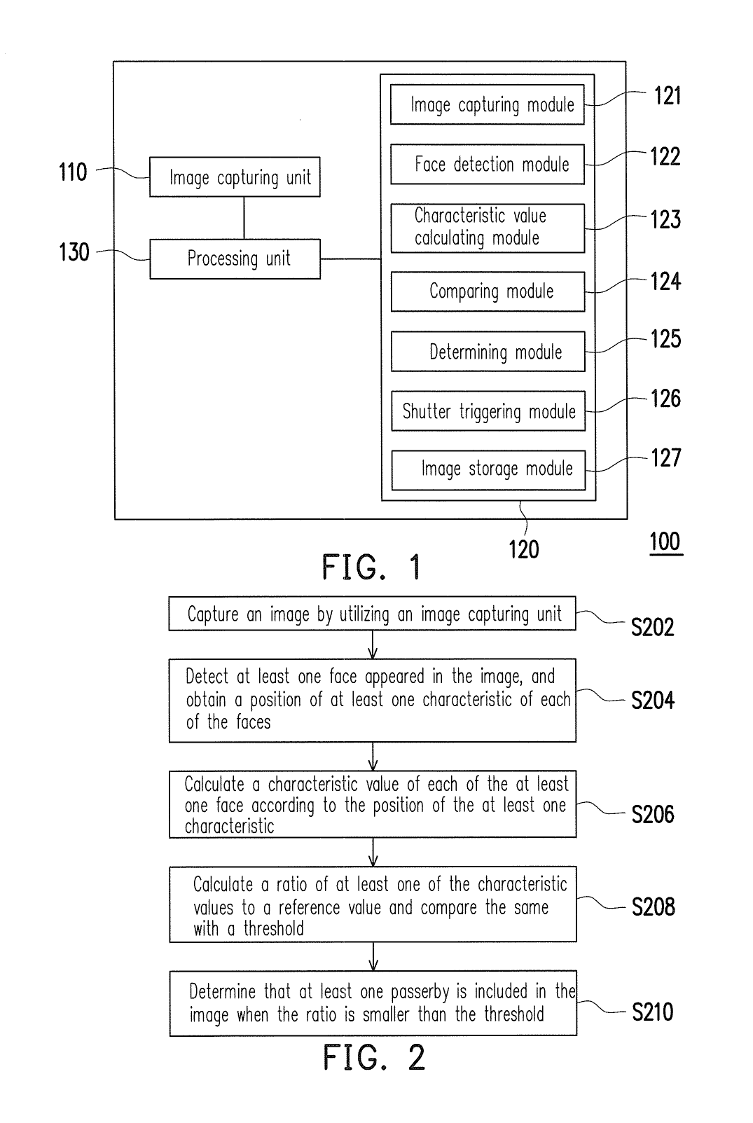

FIG. 1 is a block diagram illustrating an apparatus for passerby detection according to an embodiment of the invention. Referring to FIG. 1, in the present embodiment, a passerby detection apparatus 100 includes an image capturing unit 110, a storage unit 120 and a processing unit 130. The passerby detection apparatus 100 may be a digital camera, or a cell phone, a tablet computer or other electronic apparatuses having image capturing equipments, but types thereof are not particularly limited in the invention.

The image capturing unit 110 is, for example, a device including an optical fixed-focus lens or an optical zoom lens and including optical sensing elements such as a Charge Coupled Device (CCD) or a Complementary Metal-Oxide Semiconductor (CMOS). In the present embodiment, the image capturing unit 110 is configured to capture an image.

The storage unit 120 may be a main memory of the passerby detection apparatus 100, a fixed or a movable device in any possible forms including a random access memory (RAM), a read-only memory (ROM), a flash memory or other similar devices, or a combination of the above-mentioned devices. In the present embodiment, the storage unit 120 is configured to store software programs such as an image capturing module 121, a face detection module 122, a characteristic value calculating module 123, a comparing module 124 and a determining module 125, and store data of the images captured by the image capturing unit 110. In the present embodiment, the storage unit 120 is not limited to be one single memory device. Each of aforesaid software modules and the image data may also be stored separately in different two or more of the same or different memory devices.

The processing unit 130 is coupled to the image capturing unit 110 and the storage unit 120. The processing unit 130 may be a central processing unit (CPU) or other programmable devices for general purpose or special purpose such as a microprocessor and a digital signal processor (DSP), a programmable controller, an application specific integrated circuit (ASIC) or other similar elements or a combination of above-mentioned elements. In the present embodiment, the processing unit 130 is configured to access and execute the modules recorded in the storage unit 120, so as detect whether the passerby is included in the image. In the present embodiment, the processing unit 130 is not limited to be only one processing device, and two or more processing devices may also be used for execution together.

FIG. 2 is a flowchart illustrating a method for passerby detection according to an embodiment of the invention. Referring to FIG. 1 and FIG. 2 together, the method of the invention is adapted to the passerby detection apparatus 100 as described above. Detailed steps in the method of the present embodiment are described as below, with reference to each element of the passerby detection apparatus 100 depicted in FIG. 1.

First, the image capturing module 121 captures the image by utilizing the image capturing unit 110 (step S202). Next, the face detection module 122 detects at least one face appeared in the image, and obtains a position of at least one characteristic of each of the at least one face (step S204). In the present embodiment, the passerby detection apparatus 100 may be an electronic apparatus using Android operating system, which may obtain information related to characteristics of faces in the image through a face detection function supported by Android operating system. Therein, the characteristics may be one of a left eye, a right eye, a mouth, a contour outline of the face or a combination of the above, but selection to the characteristics is not limited thereto.

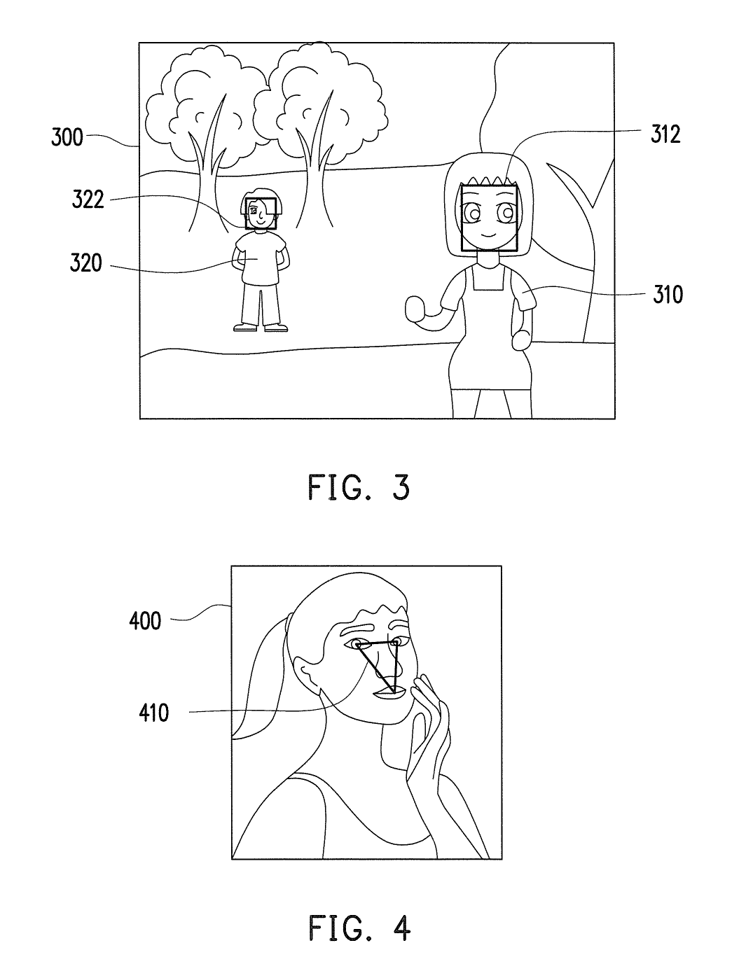

More specifically, FIG. 3 is an example illustrating the method for passerby detection according to an embodiment of the invention. As shown in FIG. 3, an image 300 includes a subject 310 and a passerby 320. Therein, in comparison with a face area of the passerby 320 (i.e., a characteristic value corresponding to the face), a face area of the subject 310 is relatively larger. In the present embodiment, when the image is captured by the image capturing unit 110, the passerby detection apparatus 100 may display a face information detected in the image through a face detection technology when previewing the image. According to the face information being detected, the passerby detection apparatus 100 may obtain a face ID corresponding to each of the faces, and positions of the characteristics of the each of the faces including coordinates at centers of the left eye and the right eye, coordinates at a center of the mouth, a border position of a face positioning frame. Here, the “face positioning frame” refers to a function usually provided in the image capturing unit 110, which is configured to position the faces in the image, as shown by squares 312 and 322 in FIG. 3. In other embodiments, the passerby detection apparatus 100 may also obtain the positions of the characteristics of the faces from the image by using other face detection algorithms or related technologies, and the invention is not limited thereto.

Thereafter, the characteristic value calculating module 123 calculates a characteristic value of each of the at least one face according to the position of at least one characteristic (step S206). More specifically, the “characteristic value” herein may be an area occupied by the face in the image, and may also be a length between the characteristics of the faces in the image, or a quantity of the characteristics of the faces in the image, or a combination of above. Person who applies the present embodiment may obtain said characteristic values by using different methods based on actual demands, and the invention is not limited thereto. Methods of using an area of a triangle, an area of a square, and a length of a straight line formed by the characteristics of the face as the characteristics are described below with reference to one embodiment respectively.

In an embodiment, the characteristic value of the face may be decided by the area of the triangle formed by two eyes and a mouth. In this embodiment, the passerby detection apparatus obtains the face information corresponding to each of the faces from the image, and utilizes the coordinates at the centers of the left eye and the right eye and the coordinates at the center of the mouth in the face information for calculating the area of the triangle formed by above-said coordinates and sets the area as the characteristic value of each of the faces.

For instance, FIG. 4 is an example illustrating the method for passerby detection according to an embodiment of the invention. Referring to FIG. 4, in this embodiment, the characteristic value of the face may be decided by the area of the triangle formed by the two eyes and the mouth. According to the face information obtained through the face detection technology, the face detection module 122 may obtain each of positions of the two eyes and the mouth corresponding to the face in an image 400. Next, according to the positions of the eyes and the mouth in the image, the characteristic value calculating module 123 may calculate the area of the triangle being formed (e.g., a triangle 410 formed by the two eyes and the mouth as depicted in FIG. 4) to be used as the characteristic value of each of the faces.

In an embodiment, the characteristic value of the face may be decided by the area of the square formed by the face positioning frame embracing the face. In this embodiment, the passerby detection apparatus obtains the face information corresponding to each of the faces from the image, and utilizes the coordinates of the face positioning frame in the face information for calculating the area of the square formed by the face positioning frame and setting the square area as the characteristic values of each of the faces.

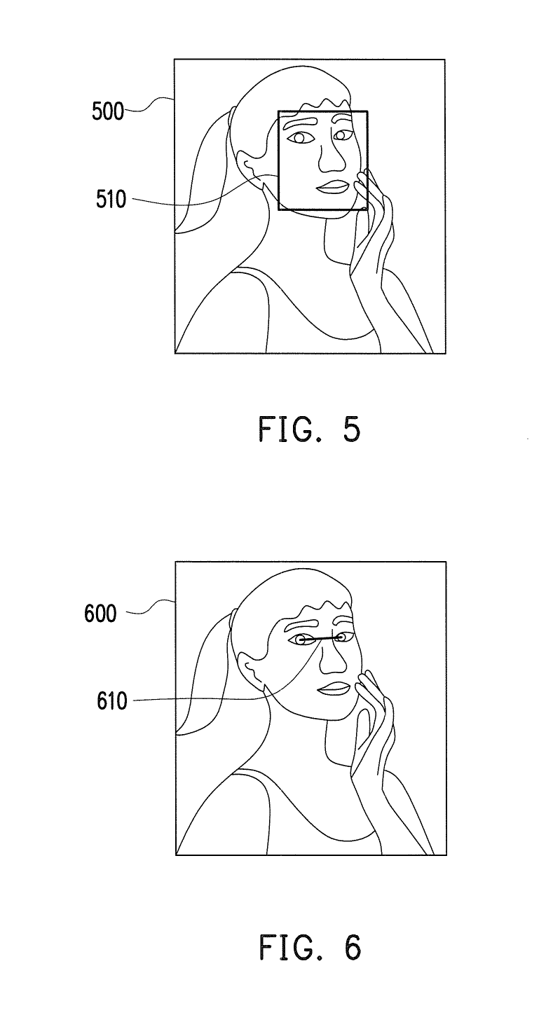

For instance, FIG. 5 is an example illustrating the method for passerby detection according to an embodiment of the invention. In the embodiment of FIG. 5, the characteristic value of the face may be decided by the area of the square formed by the face positioning frame embracing the face. Similar to the previous embodiment, according to the face information obtained through the face detection technology, the face detection module 122 may also obtain the coordinates of the face positioning frame corresponding to each of the faces in an image 500. Next, according to the coordinates of the face positioning frame, the characteristic value calculating module 123 may calculate the area of the square formed by the face positioning frame (e.g., a square 510 formed by the face positioning frame as depicted in FIG. 5) and set the area as the characteristic value of each of the faces.

In an embodiment, the characteristic value of the face may be decided by a length of a straight line formed between the two eyes of the face, that is, a distance between the two eyes. In this embodiment, the passerby detection apparatus obtains the face information corresponding to each of the faces from the image, and utilizes the coordinates at the centers of the left eye and the right eye in the face information for calculating the length of the straight line between above-said coordinates and setting the length as the characteristic value of each of the faces.

For instance, FIG. 6 is an example illustrating the method for passerby detection according to an embodiment of the invention. In the embodiment of FIG. 6, the characteristic value of the face may be decided by the distance between the two eyes. According to the face information obtained through the face detection technology, the face detection module 122 may obtain positions of the two eyes corresponding to each of the faces in an image 600. Next, according to the positions of the eyes in the image, the characteristic value calculating module 123 may calculate the distance between the two eyes (e.g., a straight line 610 as depicted in FIG. 6) and set the distance as the characteristic value of each of the faces.

Referring back to the flowchart of FIG. 2, after the characteristic value calculating module 132 calculates the characteristic value of each of the faces in the image, the comparing module 124 may calculate a ratio of at least one of the characteristic values to a reference value, and comparing the ratio with a threshold (step S208). When the ratio is smaller than the threshold, the determining module 125 determines that at least one passerby is included in the image (step S210). The reference value is used for corresponding to the subject possibly appeared in the image, and the at least one of the characteristic values is used for corresponding to the passerby possibly appeared in the image. In addition, the threshold may correspond to a sensitivity for passerby detection. In other words, in the present embodiment, a relative size of at least one of the characteristic values to the reference value together with a restriction of the threshold are used as determination conditions for determining whether the passerby is included in the image.

Hereinafter, a minimum among the characteristic values is used as at least one of the characteristic values for description. More specifically, in the present embodiment, before comparing a ration of the minimum to the reference value with the threshold, the comparing module 124 may decide the reference value according to the characteristic values of each of the faces first. The reference value may be a maximum among all of the characteristic values, or an average value or a median of all of the characteristic values, but the invention is not limited thereto. In addition, the reference value may be decided based on the faces focused by the image capturing unit 110, namely, the characteristic value corresponding to the faces being focused may be used as the reference value. Persons skilled in the art may obtain the reference value by using different methods based on the actual demands, and the invention is not limited thereto. Embodiments provided below are served to describe the methods for fetching the maximum, the average value or the median among all the characteristic values and setting the same as the reference value. The method of deciding the reference value through the faces being focused will be described later in subsequent embodiments.

More specifically, in an embodiment, the comparing module 124 may directly fetch the maximum among the characteristic values and set the maximum as the reference value. In view of above, it can be known that under a normal circumstance, the characteristic value corresponding to the subject in the image is greater than the characteristic value corresponding to the passerby in the image (e.g., the face area of the subject 310 is larger than the face area of the passerby 320 in FIG. 3). Accordingly, in the present embodiment, the comparing module 124 may directly fetch the maximum among the characteristic values and use the maximum as the reference value.

It should be noted that, under a specific circumstance, such as when the passerby passes through where between the passerby detection apparatus 100 and the subject, the characteristic value corresponding to the passerby may be greater than the characteristic value corresponding to the subject in the image. Accordingly, in order to prevent such circumstance from affecting accuracy in passerby detection, in an embodiment of the invention, the comparing module 124 may calculate the average value of the characteristic values and set the average value as the reference value. In another embodiment, the comparing module 124 may also calculate the median of the characteristic values and set the median as the reference value, so as to avoid the circumstance in which the characteristic value corresponding to the passerby may be greater than the characteristic value of the subject

On the other hand, the comparing module 124 may also decide the threshold first before comparing the ratio of the minimum to the reference value with the threshold. In an embodiment, the comparing module 124 may receive a selecting operation of a user on one of a plurality of sensitivities, accordingly select a predetermined threshold corresponding to the selected sensitivity from a plurality of predetermined threshold, and set the same as the threshold to be compared with the ratio. In other words, the passerby detection apparatus 100 may provide a menu corresponding to the sensitivities for passerby detection, which allows the user to select a proper sensitivity based on the photographing environment or the differences among subjects, so as to perform the passerby detection on the image.

For instance, the passerby detection apparatus 100 may provide a sensitivity menu including, for example, a low sensitivity, a medium sensitivity and a high sensitivity respectively corresponding to thresholds of 25%, 50% and 75%. In other words, when the passerby detection with the high sensitivity is selected by the user, the determining module 125 may determine that the passerby is included in the image once the ratio of the minimum among the characteristic values of the faces to the reference value is smaller than 75%. In contrast, when the passerby detection with the low sensitivity is selected by the user, the determining module 125 only determines that the passerby is included in the image once the ratio of the minimum among the characteristic values of the faces to the reference value is smaller than 25%. It should be noted that, although the thresholds in above embodiment are 25%, 50% and 75% respectively corresponding to the low, the medium and the high sensitivities, the invention is not limited thereto. In addition, other than being manually selected by the user, the threshold may also be automatically set by the passerby detection apparatus 100 based on the environments, or automatically preset according to image capturing modes, and the invention is not limited thereto. Persons who apply the present embodiment may apply the concept of the invention to settings of different sensitivities for passerby detection, and it falls in the technical scope of the present embodiment as long as the method for passerby detection determines whether the passerby is included in the image according to the sensitivities.

It should be noted that, in an embodiment, after the determining module 125 determines that the passerby is included in the image, the passerby detection apparatus 100 may repeat above-said steps for passerby detection to continuously detect whether the passerby is included in a next image captured by the image capturing unit 110.

In step S208 of the embodiment disclosed above, the ratio of the minimum among the characteristic values to the reference value is compared with the threshold. Nonetheless, in step S208 of another embodiment, it may also to be changed to calculate a ratio of each of the characteristic values to the reference value. When any one of the ratios is smaller than the threshold, not only is it determined that at least one passerby is included in the image, but the face to which the characteristic value corresponding to the ratio belongs being which passerby may also be further recognized. Moreover, in yet another embodiment, step S208 may also be changed to calculate a ratio of a randomly-selected characteristic value among the characteristic values to the reference value, and it is determined that the at least one passerby is included in the image once the ratio is smaller than the threshold and no further calculation on ratios of other characteristic values to the reference value is required.

In an embodiment, the passerby detection apparatus 100 may also receive a shutter signal triggered by the user through a shutter triggering module 126, and the shutter signal may be a signal sent when the user presses a shutter button for taking the image. When receiving the shutter signal, the shutter triggering module 126 may use the shutter signal to trigger a shutter of a lens for taking the image. The shutter triggering module 126 may not take the image when no shutter signal is received.

It should be noted that, herein, the term “taking the image” refers to an operation in which the user presses the shutter button to trigger the shutter of the lens to obtain the image and record the image as an image file. The term so-called “image capturing” refers to an operation that the passerby detection apparatus 100 captures an image within a field of view of the lens at each time interval by using the image capturing unit 110 when being in an active state, and displays the captured image on a display (not illustrated) thereof for the user to preview the image.

Accordingly, in the present embodiment, when determining that the passerby is included in the image captured by the image capturing unit 110, the determining module 125 may disable the shutter triggering module 126 so as to prohibit the user from taking the image since the shutter triggering module 126 cannot trigger the shutter in response to the shutter signal (i.e., the user cannot press the shutter).

In an embodiment, the passerby detection apparatus 100 may also record the image captured by the image capturing unit 110 as an image file through an image storage module 127. More specifically, when the determining module 125 determines that no passerby is included in the image captured by the image capturing unit 110 (e.g., when the passerby is excluded), the shutter triggering module 126 may trigger the shutter for capturing the image in response to the shutter signal triggered by the user, such that the image storage module 127 may record the captured image as the image file in respond to the shutter signal.

In still another embodiment, when determining that the passerby is included in the image captured by the image capturing unit 110, the determining module 125 may send a warning message to notify the user that the passerby is included in the image, so that the user may spontaneously decide whether to continue taking the image. The warning message may adopt any method capable of notifying the user, such as displaying a warning text or graphic on a display, sending a warning voice or sound, or producing vibrations.

Accordingly, in the embodiments of the invention, whether the passerby is included in the image may be determined by comparing the characteristic values of the faces, and accordingly prohibiting or permitting the user for taking the image, such that the user may take images excluding the passerby in a more convenient and intuitive way.

As described above, in another embodiment, the reference value may be decided based on the characteristic values of the faces being focused, and the method for passerby detection may also be implemented by using a focusing module (not illustrated) in the passerby detection apparatus 100. Detailed description thereof is provided below.

Generally, when the user is taking photos, the image capturing unit 110 may automatically focus on the subject, or the image capturing unit 110 may be controlled to focus on the subject being selected by the user in a preview screen. Based on above-said concept, in the present embodiment, the reference value among the characteristic values of the faces may also be decided by the faces focused by the image capturing unit 110, namely, the characteristic values of the faces being focused may be used to determine the reference value.

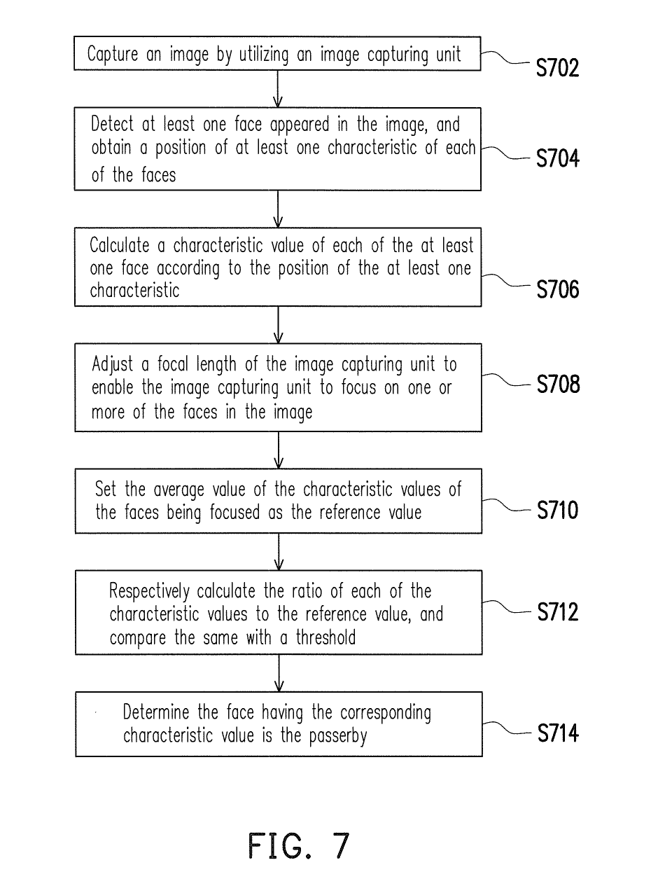

More specifically, FIG. 7 is a flowchart illustrating a method for passerby detection according to an embodiment of the invention. Referring to FIG. 1 and FIG. 7 together, the method of the invention is adapted to the passerby detection apparatus 100 as described above. Detailed steps in the method of the present embodiment are described as below, with reference to each element of the passerby detection apparatus 100 depicted in FIG. 1.

First, the image capturing module 121 captures the image by utilizing the image capturing unit 110 (step S702). Next, the face detection module 122 detects at least one face appeared in the image, and obtains a position of at least one characteristic of each of the at least one face (step S704). Thereafter, the characteristic value calculating module 123 calculates a characteristic value of each of the at least one face according to the position of at least one characteristic (step S706). Since steps S702 to S706 in the present embodiment are identical or similar to steps S202 to S206 in the foregoing embodiments, detailed description thereof is omitted hereinafter.

Unlike the foregoing embodiment, in the present embodiment, the passerby detection apparatus 100 may further include a focusing module (not illustrated) so as to further adjust a focal length of the image capturing unit 110 through the focusing module, so that the image capturing unit 110 may focus on one or more of the faces in the image (step S708). In an embodiment, the focusing module may decide the faces to be focused by using an image processing method (i.e., an automatic focusing). In another embodiment, the focusing module may receive a selecting operation of a user on the faces in the image, and accordingly adjusts the focal length of the image capturing unit 110 so that the image capturing unit 110 may focus on the faces selected by the selecting operation (i.e., a manual focusing).

Next, the comparing module 124 may use the average value among the characteristic values of the faces being focused as the reference value (step S710). Therein, in case the number of faces being focused is one, the characteristic value of such face is used as the reference value. After the reference value is decided, the comparing module 124 may respectively calculate the ratio of each of the characteristic values to the reference value, and compare the ratio with the threshold (step S712). When the ratio is smaller than the threshold, the determining module 125 may determine that the face having the corresponding characteristic value is the passerby (step S714). It should be noted that, in the present embodiment, the user may also decide the reference value by selecting one or more faces among the faces, and the invention is not limited thereto.

Accordingly, in the embodiments of the invention, the faces may be automatically focused or manually focused through the image capturing unit, so as to decide the reference value to be compared with the characteristic values of the faces. Through comparing the characteristic values of the faces one by one, whether each of the faces appeared in the image is the passerby may be more accurately determined. By combining a determination result with the shutter, the user is allowed to capture the image excluding the passerby more conveniently and intuitively.

Furthermore, the concept according to the embodiments of the invention may also be combined with the technology for removing the passerby so as to provide more diverse applications. Specifically, by using the method for passerby detection proposed according to the embodiments of the invention, which face is the passerby in the image captured by the image capturing equipment may first be determined. In this case, a plurality of images may then be taken, and the parts being predetermined as the passerby may be removed from the images by utilizing the image synthesis or filling methods, such that the steps that require the user to spontaneously select targets to be removed may be omitted and a function of automatically removing the passerby can be realized.

The present invention further provides a storage medium which records programs for executing each of the steps in aforesaid method for passerby detection. Basically, the programs are assembled by a plurality of program sections (i.e. building an organization diagram program section, approving a list program section, setting a program section, and deploying a program section). Moreover, after the program sections are loaded to the electronic apparatus for execution, the steps in the method for passerby detection may then be accomplished.

In summary, the method, the apparatus and the storage medium for passerby detection according to the embodiments of the invention are capable of deciding the characteristic value of each of the faces in the image by detecting positions of characteristics of the faces, so as to automatically determine whether the passerby is included in the image by comparing the characteristic values of the faces. When it is determined that the passerby is included in the image, the invention is capable of prohibiting the user from triggering the shutter, or capturing and recording the image when the passerby in the image moves away after the shutter is triggered by the user. As a result, the user is allowed to capture the image excluding the passerby more conveniently and intuitively by using the embodiment of the invention.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A method for passerby detection, adapted to an electronic apparatus having an image capturing unit, comprising:
capturing an image by utilizing the image capturing unit;
detecting at least one face appeared in the image, and obtaining a position of at least one characteristic of each of the at least one face;
calculating a characteristic value of each of the at least one face according to the position of the at least one characteristic;
calculating a ratio of at least one of the characteristic values to a reference value, and comparing the ratio with a threshold; and
determining that at least one passerby is included in the image when the ratio is smaller than the threshold.

2. The method for passerby detection of claim 1, wherein the step of calculating the ratio of the at least one of the characteristic values to the reference value comprises:
calculating a ratio of a minimum among the characteristic values to the reference value, and determining that the at least one passerby is included in the image when the ratio is smaller than the threshold.

3. The method for passerby detection of claim 1, wherein the step of calculating the ratio of the at least one of the characteristic values to the reference value comprises:
calculating ratios of the characteristic values to the reference value respectively, determining that the at least one passerby is included in the image when any one of the ratios is smaller than the threshold, and recognizing that the face to which the characteristic value corresponding to the ratio smaller than the threshold belongs is one of the at least one passerby.

4. The method for passerby detection of claim 1, wherein the step of calculating the ratio of the at least one of the characteristic values to the reference value comprises:
calculating a ratio of a randomly-selected characteristic value among the characteristic values to the reference value, and determining that the at least one passerby is included in the image once the ratio is smaller than the threshold.

5. The method for passerby detection of claim 1, further comprising:
prohibiting taking the image when it is determined that the at least one passerby is included in the image captured by the image capturing unit.

6. The method for passerby detection of claim 1, further comprising:
permitting taking the image and recording the image as an image file when it is determined that the at least one passerby is not included in the image captured by the image capturing unit.

7. The method for passerby detection of claim 1, wherein the at least one characteristic comprises two eyes and a mouth, and the step of calculating the characteristic value of each of the at least one face according to the position of the at least one characteristic comprises:
calculating an area of a triangle formed by positions of the two eyes and the mouth of each of the at least one face, and setting the area as the characteristic value of the face.

8. The method for passerby detection of claim 1, wherein the at least one characteristic comprises a face positioning frame embracing each of the at least one face, and the step of calculating the characteristic value of each of the at least one face according to the position of the at least one characteristic comprises:
calculating an area of the face positioning frame embracing each of the at least one face, and setting the area as the characteristic value of the face.

9. The method for passerby detection of claim 1, wherein the at least one characteristic comprises two eyes, and the step of calculating the characteristic value of each of the at least one face according to the position of the at least one characteristic comprises:
calculating a distance between the two eyes, and setting the distance as the characteristic value of the face.

10. The method for passerby detection of claim 1, wherein before calculating the ratio of at least one of the characteristic values to the reference value, and comparing the ratio with the threshold, the method further comprises:
adjusting a focal length of the image capturing unit to enable the image capturing unit to focus on one or more of the at least one face; and
setting an average value of the characteristic values of the at least one face focused by the image capturing unit as the reference value among the characteristic values.

11. The method for passerby detection of claim 10, wherein the step of adjusting the focal length of the image capturing unit to enable the image capturing unit to focus on the one or more of the at least one face comprises:
receiving a selecting operation of a user on one of the at least one face, and accordingly adjusting the focal length of the image capturing unit to enable the image capturing unit to focus on the face selected by the selecting operation.

12. The method for passerby detection of claim 10, wherein after setting the average value of the characteristic values of the at least one face focused by the image capturing unit as the reference value among the characteristic values, the method further comprises:
respectively calculating a ratio of each of the characteristic values to the reference value, and comparing the ratio with the threshold; and
determining that the face having the corresponding characteristic value is one of the at least one passerby when the ratio is smaller than the threshold.

13. The method for passerby detection of claim 1, wherein before calculating the ratio of at least one of the characteristic values to the reference value, and comparing the ratio with the threshold, the method further comprises:
receiving a selecting operation of a user on one of a plurality of sensitivities, accordingly selecting a predetermined threshold corresponding to the selected sensitivity from a plurality of predetermined thresholds and setting the predetermined threshold as the threshold to be compared with the ratio.

14. The method for passerby detection of claim 1, wherein before calculating the ratio of at least one of the characteristic values to the reference value, and comparing the ratio with the threshold, the method further comprises:
calculating an average value or a median of the characteristic values or fetching a maximum among the characteristic values, and setting the average value, the median or the maximum as the reference value.

15. The method for passerby detection of claim 1, wherein when it is determined that the at least one passerby is included in the image captured by the image capturing unit, the method further comprises:
sending a warning message to notify a user that the at least one passerby is included in the image.

16. An apparatus for passerby detection, comprising:
an image capturing unit, configured to capture an image;
a storage unit, configured to record a plurality of modules; and
a processing unit, coupled to image capturing unit and the storage unit, and configured to access and execute the modules recorded in the storage unit, and the modules comprising:
an image capturing module, configured to capture the image by utilizing the image capturing unit;
a face detection module, configured to detect at least one face appeared in the image, and obtain a position of at least one characteristic of each of the at least one face;
a characteristic value calculating module, configured to calculate a characteristic value of each of the at least one face according to the position of at least one characteristic;
a comparing module, configured to calculate a ratio of at least one of the characteristic values to a reference value, and compare the ratio with a threshold; and
a determining module, configured to determine that at least one passerby is included in the image when the ratio is smaller than the threshold.

17. The apparatus for passerby detection of claim 16, wherein the modules further comprises:
a shutter triggering module, configured to receive a shutter signal triggered by a user for triggering a shutter to take the image, and the determining module disabling the shutter triggering module to prohibit taking the image when the determining module determines that the at least one passerby is included in the image

18. The apparatus for passerby detection of claim 16, wherein the modules further comprises:
a shutter triggering module, configured to receive a shutter signal triggered by a user for triggering a shutter to take the image; and
an image storage module, configured to record the image taken in response to the shutter signal as an image file when the determining module determines that the at least one passerby is not included in the image.

19. The apparatus for passerby detection of claim 16, wherein the at least one characteristic comprises two eyes and a mouth, and the characteristic value calculating module calculates an area of a triangle formed by the two eyes and the mouth and sets the area as the characteristic value of the at least one face.

20. The apparatus for passerby detection of claim 16, wherein the at least one characteristic comprises a face positioning frame embracing each of the at least one face, and the characteristic value calculating module calculates an area of the face positioning frame embracing each of the at least one face and sets the area as the characteristic value of the at least one face.

21. The apparatus for passerby detection of claim 16, wherein the at least one characteristic comprises two eyes, and the characteristic value calculating module calculates a distance between the two eyes and sets the distance as the characteristic value of the at least one face.

22. The apparatus for passerby detection of claim 16, wherein the modules further comprises:
a focusing module, configured to adjust a focal length of the image capturing unit to enable the image capturing unit to focus on one or more of the at least one face, wherein the comparing module sets an average value of the characteristic values of the at least one face focused by the image capturing unit as the reference value among the characteristic values.

23. The apparatus for passerby detection of claim 22, wherein the focusing module receives a selecting operation of a user on one of the at least one face, and accordingly adjust the focal length of the image capturing unit to enable the image capturing unit to focus on the face selected by the selecting operation.

24. The apparatus for passerby detection of claim 22, wherein the comparing module respectively calculates the ratio of each of the characteristic values to the reference value and compares the ratio with the threshold, and the comparing module determines that the face having the corresponding characteristic value is one of the at least one passerby when the ratio is smaller than the threshold.

25. The apparatus for passerby detection of claim 16, wherein the comparing module further receives a selecting operation of a user on one of a plurality of sensitivities, accordingly selects a predetermined threshold corresponding to the selected sensitivity from a plurality of predetermined thresholds, and sets the predetermined threshold as the threshold to be compared with the ratio.

26. The apparatus for passerby detection of claim 16, wherein the comparing module further calculates an average value or a median of the characteristic values or fetches a maximum among the characteristic values, and sets the average value, the median or the maximum as the reference value.

27. A non-transitory storage medium, recording programs to be loaded into an electronic apparatus to perform steps of:
capturing an image by utilizing an image capturing unit of the electronic apparatus;
detecting at least one face appeared in the image, and obtaining a position of at least one characteristic of each of the at least one face;
calculating a characteristic value of each of the at least one face according to the position of the at least one characteristic;
calculating a ratio of at least one of the characteristic values to a reference value, and comparing the ratio with a threshold; and
determining that at least one passerby is included in the image when the ratio is smaller than the threshold.
